(19) United States
(12) Patent Application Publication
(10) Pub. No.: US 2006/0252849 A1
(43) Pub. Date: Nov. 9, 2006

(54) Antifungal compositions and methods for manufacturing mold resistant materials

(76) Inventors: Gregory Rose, Glen Allen, VA (US); Michael Kanney, Glen Allen, VA (US)

Correspondence Address: HARNESS, DICKEY & PIERCE, P.L.C., P.O. BOX 8910, RESTON, VA, 20195, US

(21) Appl. No.: 11/401,319

(22) Filed: Apr. 11, 2006

Related U.S. Application Data
(60) Provisional application No. 60/669,889, filed on Apr. 11, 2005.

(51) Int. Cl. C09D 5/16

(52) U.S. Cl. 523/122

(57) ABSTRACT

Conventional building materials such as plywood and wallboard are both widely used in residential and commercial interior construction and highly susceptible to mold and fungal growth when utilized in a moist environment or periodically subjected to wetting. Mold growth has been associated with certain health risks attributed to toxic airborne mold spores, unpleasant smells and, at best, is considered unsightly. The invention provides a two-part antifungal formulation prepared from at least a binder admixture and a preservative admixture that can be applied to surfaces and/or incorporated within materials that are susceptible to mold growth. The antifungal formulation forms an antifungal coating on, and in some instances at least partially through, the substrate that will both inhibit mold and fungal growth while improving the persistence of the antifungal effects and/or reducing the concentration of antifungal agents necessary to achieve a desired level of antifungal activity.

### PRIORITY STATEMENT

This application claims priority under 35 U.S.C. § 119 from U.S. Provisional Patent Application No. 60/669,889, which was filed on Apr. 11, 2005, the contents of which are herein incorporated by reference in its entirety.

### BACKGROUND OF THE INVENTION

1. Field of the Invention

This invention relates to compositions and methods of applying such compositions for increasing the fungal resistance of the treated materials. More particularly, the invention relates to compositions, manufacturing methods and application methods that will tend to improve the mold, fungus and/or bacterial resistance of conventional wood, paper and/or gypsum-based substrates that may be used in building construction materials such as decking, wallboard or ceiling panels.

2. Description of Related Art

Fungal growth will tend to occur in environments where four key elements are present including 1) fungal spores, 2) nutrients sufficient to support fungal growth, 3) moisture and 4) A temperature within a range suitable for the particular fungus. These four elements are frequently found or created in spaces suitable for or associated with buildings and spaces intended for human use or habitation. Although various environments provide different amounts of these key elements, the presence of water vapor and fungal spores are essentially unavoidable in most buildings. Not surprisingly, therefore, common fungi, such as mold and mildew, are frequently found in and/or on the walls of buildings.

Fungi can be particularly problematic in installations and facilities that are poorly ventilated, poorly sealed, or afflicted with plumbing problems whereby the building materials are repeatedly exposed to moisture. The walls of portable and temporary buildings are particularly susceptible to fungus growth because water often seeps into the wall and/or ceiling around the openings and joints of such structures. In buildings having poor ventilation or inefficient heating and air conditioning systems, the building walls are more likely to become breeding grounds for fungus. In some instances, mold problems may become more than cosmetic, particularly when the mold produces and releases toxins and/or allergens that can render a structure uninhabitable and/or require expensive and time consuming remediation efforts.

Conventional gypsum-based construction materials have the disadvantage that they tend to support fungus growth when used in a moist environment. Naturally occurring organic matter that is incorporated in conventional gypsum board products, such as cellulose, paper fibers, starch, and other organic contaminants, can provide nutrients suitable for supporting growth of many strains of fungus. Accordingly, when conventional gypsum board becomes chronically moist or water damaged due to excessive humidity, water leaks, condensation, or flooding, fungus growth is a near certainty on the affected gypsum board. This fungus growth can be exacerbated by the use of vinyl wall coverings on the interior surface of the walls that will tend to trap moisture inside the gypsum board and thereby facilitate the fungus growth.

Gypsum wallboard and gypsum panels are traditionally manufactured by a continuous process in which a gypsum slurry is generated by mixing calcium sulfate hemihydrate (also known as calcined gypsum), water, and other agents and then depositing this gypsum slurry on a base paper sheet. The gypsum slurry may include additives such as cellulose fibers that help to strengthen the gypsum core or starch for promoting adhesion between the gypsum core and the paper facing. The gypsum core is then typically finished by applying a finish paper sheet over the exposed face of the gypsum core and sealing the edges of the base and finish paper sheets together with a starch paste. The paper sheets with the encompassed gypsum slurry may then be passed between parallel upper and lower forming plates or rolls in order to generate a substantially uniform layer of unset gypsum sandwiched between the paper sheets (also referred to as facings or liners).

This intermediate product is then maintained under conditions under which the core begins to set and harden as the calcium sulfate hemihydrate reacts with the water present in the slurry to convert the hemihydrate into a matrix of interlocking calcium sulfate dihydrate crystals (gypsum). After the gypsum core is sufficiently set, the intermediate product may be cut into shorter lengths or even individual boards or panels of predetermined length. After being cut, step, the gypsum boards are typically passed through one or more drying ovens or kilns where the boards are dried so as to evaporate excess water remaining from the hydration process.

The fully dried gypsum adheres well to the paper facing sheet materials as long as the gypsum board is kept dry. However, paper facing materials have a number of inherent properties that can be detrimental in a gypsum wallboard product. As discussed above, cellulose, which typically is a primary component of the paper facing material, can serve as a nutrient for fungus growth. Paper facing layers used on conventional gypsum board also tend to delaminate from the gypsum core when the paper becomes damp as the result of leaks or condensation.

Various attempts have been made to improve the fungal resistance of gypsum panels. In some instances the facing paper coverings have been pretreated with a fungicide. Such pretreated papers are limited by the inability of many fungicides to retain their efficacy throughout the panel drying process due to the high temperatures used in the kilns. Environmental regulations also limit the composition and concentration of fungicide(s) that can be present on the surface of the paper and allowable surface concentrations may not be sufficient to protect both the paper and the gypsum core.

Other attempts included adding fungicides to the gypsum slurry, resulting in different problems. Water-soluble fungicides tend to migrate with the water during the drying process, thereby tending to accumulate on the covering when the water evaporates. In addition to leaving the core unprotected, such a result may produce a paper covering having a concentration of fungicide that is too high to meet environmental regulations. Conversely, fungicides that are insoluble or only slightly soluble can be difficult to disperse uniformly in the aqueous slurry and typically provide little or no protection for the covering material.

Various compounds added directly to the gypsum slurry can also have detrimental effects on the properties of the set gypsum product. For example, when boric acid, a known fungicide, is added to a gypsum slurry in a quantity sufficient to provide significant mold growth inhibition, the resulting panels can become so embrittled that they cannot endure normal processing and shipping operations without unacceptable levels of cracking and chipping.

Another technique for improving the fungal resistance of gypsum board is to utilize a two-step process whereby a fungicide-containing core is covered with fungicide-treated paper layers. In addition to the problems discussed above with respect to the various paper and core treatments, the two-step process will tend to be more expensive than a single step process and may not significantly improve the overall performance of the final board product. A need thus remains for gypsum based building products that exhibit improved fungal resistance and/or improved duration of such fungal resistance.

### SUMMARY OF THE INVENTION

The present invention encompasses a variety of antifungal formulations that can be applied to substrates to provide improved fungal resistance and various methods for applying such formulations to various products during their original production or through field treatment of conventional materials. Exemplary embodiments of the invention utilize a two-part treatment formulation comprising an aqueous solution or dispersion of one or more antifungal organohalogen compounds, preferably selected from those compounds that have already been approved by the applicable regulatory bodies for use in building and/or paper products, in combination with a separate binder composition incorporating one or more water-based polymer resins and one or more suitable cross-linking agents that will react to form a polymer network having limited water solubility.

The two parts of the formulation are maintained separately until shortly before application to the substrate at which time they may be mixed and applied to an unprotected or insufficiently protected surface to form a treated surface. Without being bound by any particular theory or mechanism, it is believed that the polymer resin(s) and the cross-linking agent(s) will react to form a polymer network on, and in some cases into, the surface of the treated substrate that least partially encapsulates or seals discrete preservative particles or droplets to form a composite surface layer. As a result of the polymeric component of the formulation, the composite surface layer will tend to release small amounts of the antifungal compound(s) when wetted. By slowly releasing the antifungal compound(s) during those periods when the treated surface is most susceptible to fungal or bacterial growth, i.e., when wet, the treatment formulations of the present invention can extend the period during which the treated surface can successfully inhibit microbial growth.

This two-part formulation can also improve the performance of the treated surface over conventional antifungal treatments by reducing the amount of the biocide(s) necessary to achieve the desired degree of suppression of the microbial growth and/or by prolonging the period during which the treated surface can suppress microbial growth. It is anticipated that satisfactory results can be achieved by applying one or more of the exemplary formulations to the treated surface at a rate whereby the formulation actives will comprise between about 0.1% to about 1% of the net weight of the layer being coated. As will be appreciated, the application rate will depend on a variety of factors which may include, for example, the particular biocide or combination of biocides selected, the composition, thickness and porosity of the material to which the formulation is applied, the particular environment for which the product is intended, the intended price point of the product and the degree and/or duration of microbial resistance desired for the product.

When used for treating paper products, for example, the exemplary formulations of the invention can be applied to the paper at any point during paper manufacture following initial formation of the wet paper web within a paper forming machine. The formulation can be applied by immersing the paper web, surface flooding, spraying, rolling or any other method suitable for applying a liquid treatment to a paper web. Although, as suggested above, the requirements for various products may be quite different, a general parameter for judging the effectiveness of a particular treatment and formulation will be the period of time that the formulation can suppress fungal growth in the continuous presence of both moisture and active mold cultures. The ability of a particular formulation to suppress substantially all fungal growth for at least 30 days under these conditions would be considered good.

More specifically, the present invention relates to antifungal formulations that may be applied to a substrate comprising a binder admixture including a film forming resin and a compatible cross-linking agent and a preservative admixture including at least one compound exhibiting fungicidal activity and a liquid carrier, wherein the binder admixture and the preservative admixture are combined at a volume ratio of between 10:1 and 1:1 to create the antifungal formulation. The binder admixture may include polyvinyl alcohol and may also include one or more polymeric modifiers selected from a group consisting of polyamines, polyamidoamines, polyvinyl acetate, styrene butadiene, polyacrylics, polystyrene maleic anhydride and mixtures thereof. If a polymeric modifier is present, it may constitute from about 0.5% to about 5.0% of the dry weight of the binder admixture. The binder admixture may also include one or more additives selected from a group consisting of solubilizers, surfactants, dispersants, dyes, pigments, viscosity modifiers and mixtures thereof. The binder admixture may also include one or more additives selected from a group consisting of aldehydes, dialdehydes, metallorganic complexes of titanium and zirconium, borates, dicarboxylic acids, water soluble copper salts and mixtures thereof. The compound(s) that exhibit fungicidal activity will be selected from a group consisting of those organohalogens registered by the U.S. Environmental Protection Agency (EPA), or the corresponding ministry, department, agency or other regulatory body in the relevant jurisdiction(s), for application to paper and may be selected from a group consisting of isothiazolines, iodoaromatic sulfones, iodoorganics, chloroorganics, bromoorganics, benzoisothiazolines, cyanonitriles, bromonitrostyrene, quaternary ammonium salts and mixtures thereof.

The present invention also encompasses applying such antifingal formulations to a substrate to increase the fungal resistance of the substrate by preparing a binder admixture including a film forming resin and a compatible cross-linking agent; preparing a preservative admixture including at least one compound exhibiting fungicidal activity and a liquid carrier, combining the binder admixture and the preservative admixture at a volume ratio of between 10:1 and 1:1 to form an antifungal formulation; applying the antifungal formulation to the substrate; and drying the antifungal formulation to form an antifungal coating on the coated substrate. The antifungal formulation may be applied to the substrate using any appropriate coating process or method including, for example, methods selected from a group consisting of rod coating, roll coating, size press, immersion, spray coating, film coating, flooding, and gravure printing. After drying, the antifungal coating is expected to constitute from about 0.01% to about 2% of the weight of the coated substrate, the weight of the coating being a function of, for example, the substrate construction, the demonstrated efficacy of the particular antifungal composition, the species of fungi and the moisture conditions expected in the use environment. The substrate being coated may have an initial moisture content of from about 5% to about 90% and may typically have a final moisture content of less than about 10%. The antifungal formulation may be applied in a manner to ensure that the formulation permeates the substrate or, alternatively, may be applied whereby the antifungal formulation is found primarily in one or more outer portions of the substrate. The substrates to which the antifungal formulation may be applied include paper product having, for example, a weight of from about 5 g/m² to about 40 g/m², which in turn, may be applied to one or more core materials to form, for example, gypsum wallboard.

The method of applying the antifungal formulation may also include preparing a binder admixture including a film forming resin, a compatible cross-linking agent and a first dye, preparing a preservative admixture including at least one compound exhibiting fungicidal activity, a second dye and a liquid carrier, and combining the binder admixture and the preservative admixture at a volume ratio of between 10:1 and 1:1 to form an antifungal formulation having a characteristic color. The antifungal formulation having the characteristic color may then be applied to a substrate with the intensity and uniformity of the characteristic color on the substrate being used by the operator applying the formulation to guide the application. The first and second dyes may also be selected to provide a color change upon drying, for example, in which the intensity of the characteristic color decreases upon drying or changes to a secondary color characteristic of the dry composition, again serving as a useful indicator for those applying the formulation as to its state. The first and second dyes or pigments are preferably selected so that upon drying they are “fixed” to the substrate material to suppress leaching from the treated substrate into latex or oil base fluids. Depending on the compositions utilized and the intended application, the antifungal formulation may also be prepared by combining the binder admixture and the preservative admixture with a suitable fluid diluent to obtain a desired concentration and/or viscosity before applying the antifungal formulation to the substrate.

### DETAILED DESCRIPTION OF EXAMPLE EMBODIMENTS

As used herein, “fungi” or “fungus” refers generally to the diverse group of eukaryotic microorganisms whose cells contain a nucleus, vacuoles, and mitochondria such as algae, molds, yeasts, mushrooms, and slime molds. Exemplary fungi include Ascomycetes (e.g., Neurospora, Saccharomyces, Morchella), Basidiomycetes (e.g., Amanita, Agaricus), Zygomycetes (e.g., Mucor, Rhizopus), Oomycetes (e.g., Allomyces), and Deuteromycetes (e.g., Penicillium, Aspergillus).

As used herein, “algae” refers to those eukaryotic organisms that contain chlorophyll and carry out oxygenic photosynthesis. Exemplary algae include Green Algae (e.g., Chlamydomonas), Euglenids (e.g., Euglena), Golden Brown Algae (e.g., Navicula), Brown Algae (e.g., Laminaria), Dinoflagellates (e.g., Gonyaulax), and Red Algae (e.g., polisiphonia).

As used herein, “mold” refers to a filamentous fungus, generally a circular colony that may be cottony, wooly, etc. or glabrous, but that do not include filaments that are organized into large fruiting bodies, such as mushrooms. One exemplary mold is the Basidiomycetes called wood-rotting fungi. Two types of wood-rotting fungi are commonly referred to as “white rot” and “brown rot.” A biological activity of many fungi, especially many members of the Basidiomycetes, is the decomposition of wood, paper, cloth, and other products derived from natural sources. The organisms such as the Basidiomycetes that attack these products are typically those that are able to utilize cellulose or lignin as carbon and energy sources.

Lignin is a complex polymer in which the building blocks are phenolic compounds and is an important constituent of woody plants. The natural decomposition of lignin is almost exclusively the result of action by wood-rotting fungi. Brown rot attacks and decomposes the cellulose while leaving the lignin substantially unaffected while white rot exhibits a broader based attack and decomposes both cellulose and lignin.

As used herein, “yeast” refers to unicellular fungi, most of which are classified with the Ascomytes, and “mushrooms” refer to filamentous fungi that typically form large complex structures called fruiting bodies (that, in certain species, are edible) from which spores can be released. “Slime molds” refers to those nonphototrophic eukaryotic microorganisms that have exhibit some similarity to both fungi and protozoa and can be further divides into cellular slime molds, whose vegetative forms are composed of single amoeba-like cells, and the acellular slime molds, whose vegetative forms are masses of protoplasms of indefinite size and shape (plasmodia). Slime molds live primarily on decaying plant matter, such as wood, paper, and cloth.

As used herein, “fungal resistant” refers to a substrate (e.g., a gypsum-based wall panel or a paper product) that exhibits significantly less fungal growth under conditions that result in fungal growth on a generally similar, but non-fungal resistant substrates. As used herein, fungal resistant substrates are those that exhibit at least a 75% reduction in the mold growth when compared to the surface of an equivalent substrate that is not fungal resistant. The fungal resistant substrate will include at least one fungicide or biocide compound that will kill, destroy, inhibit, or inactivate eukaryotic microorganisms and thereby suppress their growth.

The fungal resistant gypsum-based wall panel will preferably meet the necessary requirements to be certified as a fungal resistant gypsum-based wall panel. In order to be so certified, the fungal resistant gypsum-based wall panel, upon testing, must be approved by at least one of the relevant building codes and insurance rating bureaus and standards typically known to those of skill in the art. Such fungal resistant gypsum-based wall panels, upon testing, will meet or exceed the requirements of a fungal resistant gypsum-based wall panel, as defined by the relevant code sections or standards established by one or more certifying entities such as Building Officials and Code Administrators International, Inc. (BOCA) National Building Code; Standard Building Code (SBC); Uniform Building Code (UBC); American Society for Testing Materials (ASTM); American Wood-Preservers' Association (AWPA); Underwriters Laboratories, Inc. (UL); U.S. Department of Defense (DOD); City of Los Angeles, Calif.; City of New York, N.Y. Building Code; International Conference of Building Officials (ICBO); and Southern Building Code Congress International, Inc. (SBCCI).

The fungal resistant gypsum-based wall panel can either be surface treated or integrally treated. As used herein, a “surface treated gypsum-based wall panel” refers to a gypsum-based wall panel wherein only the outwardly facing surface(s) of the panel, i.e., the facing layers, are treated with a biocide, fungicide, or combination thereof. As used herein, an “integrally treated wall panel layer” refers to a gypsum-based wall panel component, such as one or both of the facing layers or the gypsum slurry incorporates at least one biocide, fungicide, or combination thereof. As used herein, an “integrally treated gypsum-based wall panel” refers to a gypsum-based wall panel wherein both the facing layers and the gypsum slurry used in forming the wall panel independently incorporate at least one biocide, fungicide, or combination thereof.

As used herein, a “fungicide” or “antifungal agent” refers to a chemical that will kill, destroy, inhibit, or inactivate a fungus to prevent growth. The chemical can be synthetic or biosynthetic and can include both organic and inorganic compounds. The fungicide can be formulated as a solid (e.g., powder), microcapsules, liquid, solution, suspension, emulsion, gel, or a combination thereof. Regardless of the particular formulation, the “fungicide” or “antifungal agent” includes at least one chemical compound that will kill, destroy, inhibit, or inactivate one or more types of eukaryotic microorganisms to a degree sufficient to suppress or prevent their growth.

The fungicides contemplated for use in this invention are expect to include any chemical that has been or is later approved by the relevant controlling government agency or agencies, e.g., Environmental Protection Agency (EPA) or the Food and Drug Administration (FDA) for use in paper and/or construction materials. Additionally, the fungicide will preferably comply with the Federal Insecticide, Fungicide, and the Rodenticide Act (FIFRA) and the Federal Environmental Biocide Control Act (FEPCA) of 1972.

The present composition further desirably includes at least a first antifungal agent. Any desired antifungal agent may be employed, so long as it is capable of forming a generally uniform, stable admixture with the other components of the composition. Desirably, the antifungal agent will be one that is capable of weakening, killing, neutralizing or otherwise impairing a microorganism upon direct contact therewith, or upon contact within a zone of inhibition surrounding the antifungal agent.

Once the antifingal composition is applied and dried, it can form a film that entraps not only any debris present on the treated surface or within the treated substrate, but also the antifungal agent(s) to provide for a controlled release in the presence of moisture. Without being bound by any particular theory or mechanism, it is believed that due at least in part to the improved moisture resistance provided by the film, the treated substrate will typically exhibit improved long-term antifungal activity, i.e., for up to at least about 48 hours, preferably for up to at least about 30 days, and more preferably for up to at least about 2 years, as measured according to ASTM D5590.

Particularly advantageous antifungal agents are those that have relatively low water solubility so that the antifungal agent will not substantially leach out of the treated material and/or will not tend to wick or migrate through the treated material under wet conditions, thereby maintaining a more uniform fungal resistance. That is, in addition to the water-resistant nature associated with the polymeric portion of the composite film, utilizing antifungal agents that independently exhibit relatively low water solubility can improve the durability and uniformity of the antifungal activity.

Antifungal agents having a water solubility of from about 0.10 ppm (parts per million) to about 0.5% are expected to exhibit this capability, and may be utilized in the present compositions. Examples of suitable antifungal agents thus include, but are not limited to, zinc 2-pyridinethiol-1-oxide, sodium 2-pyridinethiol-1-oxide, sodium borate, zinc borate, barium metaborate, calcium borate, iodo alkynyl alkyl carbamate, diiodomethyl-p-tolyl sulfone, 2-4-thiazolyl-benximidazole, 4,5-dichloro-2-n-octyl-4-isothiazolin-3-one, 2,4,4,-trichloro-2-hydroxy-diphenyl-ether, zinc dimethyldithiocarbamate, zinc 2-mercaptobenzothiazole, potassium n-hydroxymethyl-n-methyldithiocarbamate, sodium 2-mercaptobenzothiazole, 5-hydroxymethoxymethyl-1-aza-3,7-dioxa bicyclooctane, 2,3,5,6-tetra-chloro-4-pyridine, zinc 2-pyridinethiol-1-oxide, N-trichloromethylthiophthalimide, tetrachloroisophthalonitrile, including salts of any of these, and mixtures of any of these and their salts.

Certain of these compounds as well as other antifungal agents are available in various commercially available biocides and fungicides including, for example, KATHON™ from Rohm and Haas Co., a mixture of isothiazolines; ERRIDEN™ from Rohm and Haas Co., a mixture of isothiazolines, surfactant and solvent; AMICAL™ from Dow Chem. Co., a dispersion including an iodoaromatic sulfone; B-6773™ from Intace Corp., a mixture of iodoorganic and chloroorganic compounds; BONOPOL™ from Dow Chem. Co. including a bromoorganic tertiary alcohol; DBNPA™ from Dow Chem. Co. including a bromonitrile amide; PROXEL™ from ICI Chem. Co., a benzoisothiazoline solution; TEKTAMER™ from Bayer Chem. Co. a cyanonitrile dispersion; BNS™ from Dow Chem. Co., a brononitrostyrene solution; and MAQUAT™ from Mason Chem. Co., solutions including a variety of quaternary ammonium salts.

Of these compounds and compositions, the antifungal agents that can be processed to obtain relatively small particle size and/or that exhibit higher levels of antifungal activity may be utilized in antifungal compositions that will penetrate at least partially through the matrix of the material to which the composition is applied. From the above list, zinc 2-pyridinethiol-1-oxide, sodium 2-pyridinethiol-1-oxide, iodo alkynyl alkyl carbamate, 2,3,5,6-tetra-chloro-4-pyridine, and zinc 2-pyridinethiol-1-oxide are examples of antifungal agents suitable for use in these applications. Those having a larger particle size, and/or requiring relatively higher concentrations to achieve the same level of antifungal activity are better suited for those applications in which the composition will form a coating layer on the surface of the treated substrate, but will not exhibit any significant penetration into the substrate matrix.

The antifungal agent(s) selected will be included in the composition in an amount that, once applied to a substrate and dried, will maintain a concentration of actives sufficient to weaken, kill, neutralize or otherwise impair fungal growth. As will be appreciated, the effective amount will vary depending upon the particular antifungal agent chosen, and those of ordinary skill in the art are readily able to determine such amounts using routine experimentation. It is contemplated, however, that the antifungal agent(s) may be present in the initial composition in amounts ranging from about 0.01 wt % to about 10.0 wt % active, or from about 0.1 wt % to about 7 wt % active, or even from about 1 wt % to about 5 wt % active, based upon the total weight of the formulation.

The present compositions may also include other ingredients for increasing the processability, stability, efficacy, coatability, visibility, etc., of the composition and may also include secondary antifungal agents. Examples of such ingredients that may optionally be used in the present composition include, but are not limited to, wetting agents, dispersing aids, thickeners, surfactants, pigments, defoaming agents, coalescing agents, fillers, reinforcing agents, adhesion promoters, plasticizers, flow control agents, ultraviolet absorbing agents, antistatic agents, emulsifiers, antioxidants, UV stabilizers, dyes, colorants, indicators or combinations of these. Zinc oxide, for example, is an additive that can included for coloring the composition and providing some additional antifungal activity. The amounts of any such additives to be included in the present compositions will depend upon the particular additive chosen, but generally speaking such additives are typically utilized in amounts ranging from about 0.01 wt % to about 15 wt %, based upon the total weight of the composition.

### EXAMPLE 1

An exemplary binder composition was prepared by combining 96 parts of a 7% solution of polyvinyl alcohol resin with 2 parts of a 40% glyoxal composition. 2 parts of a blue colored amine dye was added to the binder composition to aid visualization during application. The pH of the binder solution was adjusted to a range of 4.0-4.5 through the addition of phosphoric acid.

An exemplary preservative composition was prepared from a 40% solids blend of two organohalogen fungicides, specifically tetrachloroisophthalonitrile (15-49%) and p-[(diiodomethyl)sulfonyl]toluol (5-29%). This composition is commercially available from Intace Corporation as B-6773.

The binder and preservative compositions were mixed at a volume ratio of 9:1 to form a slightly viscous dispersed emulsion and applied shortly after mixing to a dry 40 lb/1000 ft² grayback wallboard sheet using a conventional rod coater. The rate of addition was adjusted to reach a target dry net weight of 1% of the net weight of the uncoated paper or approximately 0.4 lbs./1,000 ft² (18 g/m²).

The coated paper was then dried to a target moisture level of about 7% to obtain a finished paper having a good uniform, slightly glossy appearance. The coated paper was then tested and determined to meet or exceed all the required physical test parameters for this grade of paper including both tensile test and surface sizing. The coated paper was then tested for mold inhibition testing according to ASTM G-21 for paper. The coated paper exhibited excellent resistance to mold growth during a sixty day trial during which it was continually subjected to direct exposure to moisture and active mold and/or fungus cultures.

### EXAMPLE 2

Another exemplary binder composition was prepared by combining 97 parts of a 7% polyvinyl alcohol solution, 1 part of a 40% solution of glutyraldehyde and 2 parts of a blue contrast dye cited.

Another exemplary preservative composition was prepared from a 40% solid solution of an antifungal diiodomethyl-p-tosylsulphone (90-95%) compound. This compound is commercially available from DOW Chemical Co. as AMICAL.

The binder composition and preservative composition were then mixed at a volume ratio of about 88:12 to form a slightly viscous emulsion. The combined emulsion was applied shortly after mixing to a dry 40 lb/1000 ft² grayback wallboard sheet using a conventional rod coater. The rate of addition was adjusted to reach a target dry net weight of 0.7% of the net weight of the uncoated paper or approximately 0.28 lbs/1,000 ft² (12.6 g/m²).

The coated paper was then dried to a target moisture level of about 10% to obtain a finished paper having a good uniform, slightly glossy appearance. The coated paper was then tested and determined to meet or exceed all the required physical test parameters for this grade of paper including both tensile test and surface sizing. The coated paper was then tested for mold inhibition testing according to ASTM G-21 for paper. The coated paper exhibited substantially no mold growth during a sixty day trial during which it was continually subjected to direct exposure to moisture and active mold and/or fungus cultures.

### EXAMPLE 3

Another exemplary binder composition was prepared by combining 99 parts of a 2% solution of a low viscosity grade of polyvinyl alcohol with 1 part of a 40% glyoxal solution.

Another exemplary preservative composition was an aqueous solution of the biocide 4,5-dichloro-2-n-octyl-4-isothiazolin-3-one (4.0-4.5%) (CAS Reg. No. 64359-81-5), related reaction products (less than 0.2%), benyl alcohol (6-9%), and an anionic/nonionic surfactant mixture (25-31%). This composition is commercially available from Rohm and Haas Co. as ERIDEN™ Microbiocide.

The binder composition and preservative composition were then mixed at a volume ratio of about 80:20 to form a slightly viscous emulsion. The combined emulsion was applied shortly after mixing to a wet, i.e., having a moisture content of approximately 30%, 40 lb/1000 ft² grayback wallboard sheet just after paper formation using a conventional sprayer. The rate of addition was adjusted to reach a target dry net weight of 0.25% of the net weight of the uncoated paper or approximately 0.1 lb/1,000 ft² (4.5 g/m²).

The coated paper was then dried to a target moisture level of about 7-10% to obtain a finished paper having a good uniform, slightly glossy appearance. The coated paper was then tested and determined to meet or exceed all the required physical test parameters for this grade of paper including both tensile test and surface sizing. The coated paper was then tested for mold inhibition testing according to ASTM G-21 for paper. The coated paper exhibited only minor mold growth during a thirty day trial during which it was continually subjected to direct exposure to moisture and active mold and/or fungus cultures.

### EXAMPLE 4

Another exemplary binder composition was prepared by combining 98 parts of a 2% solution of a low viscosity grade of polyvinyl alcohol, 1 part of a 40% glyoxal solution and 1 part copper acetate.

Another exemplary preservative composition was prepared as a nominal 1.5% aqueous solution of isothiazolins, specifically a 3:1 mixture of 5-chloro-2-methyl-2H-isothiazol-3-one and 2-methyl-2H-isothiazol-3-one biocides (1-3%) (CAS Reg. No. 55965-84-9) and magnesium nitrate (1-3%). This composition is available commercially from Rohm and Haas Co. as KATHON™ FP 1.5 BIOCIDE.

The binder composition and preservative composition were then mixed at a volume ratio of about 85:15 to form a slightly viscous emulsion. The combined emulsion was applied shortly after mixing to a wet, i.e., having a moisture content of approximately 30%, 40 lb/1000 ft² grayback wallboard sheet just after paper formation using a conventional sprayer. The rate of addition was adjusted to reach a target dry net weight of 0.2% of the net weight of the uncoated paper or approximately 0.08 lb/1,000 ft² (3.6 g/m²).

The coated paper was then dried to a target moisture level of about 7-10% to obtain a finished paper having a good uniform, slightly glossy appearance. The coated paper was then tested and determined to meet or exceed all the required physical test parameters for this grade of paper including both tensile test and surface sizing. The coated paper was then tested for mold inhibition testing according to ASTM G-21 for paper. The coated paper exhibited only minor mold growth during a thirty day trial during which it was continually subjected to direct exposure to moisture and active mold and/or fungus cultures.

The compositions may be applied as aqueous solutions or emulsions or may include one or more additional solvents. Aqueous compositions, particularly those substantially free of additional organic solvents, may be particularly advantageous in addressing volatile organic compound (VOC) issues during application and storage of the treated products and reduce the cost of meeting environmental and workplace regulations relating to such volatile species. Particularly with reference to in-situ applications of the composition may provide an additional benefit of sealing debris, including, for example, mold or mold spores, to the treated surface and thereby reduce contamination of other surfaces and/or human exposure to the debris and reduce the chance of irritating those having particular sensitivity or allergies to odors or organic debris.

Particularly with regard to in-situ applications, dye may be added to one or both of the binder composition and the preservative composition. The dye may be used as a qualitative measure of the application density and, if contrasting dyes (for example red and blue) are used in the two compositions, the intensity and/or the relative contributions of the two initial dyes can be used as a qualitative and dynamic measure of the mixing ratio as the resulting blended formulation is applied to the surface being treated.

Compositions according to the present invention are prepared by combining the various components of the binder composition and the various components of the preservative composition to obtain two separate and substantially uniform admixtures. These admixtures are then combined, either with or without the introduction of an additional dispersant, carrier or solvent, and applied as the two admixtures are being mixed (e.g., within a single spray nozzle fed by two separate admixture lines or within the spray itself), immediately after mixing or shortly thereafter (e.g., in a mixing chamber from which the formulation is transferred to the spray nozzle) to the surface being treated.

As will be appreciated, the various ingredients used to form the admixtures may be combined using any conventional method and equipment sufficient to obtain the desired degree of uniformity in the solution, dispersion, suspension, emulsion, gel, etc. Similarly, the admixtures may be subsequently combined and applied using any conventional equipment, or combination of equipment, and processes, such as spray heads, laminar coaters, roll coaters, stirred vessels, etc., that provide the desired degree of mixing for the particular admixtures and the expected viscosity range of the admixtures and/or the combined formulation.

Due to the unique combination of capabilities of the present formulations, they may be applied to a wide variety of substrates and may be utilized in a wide variety of industries. Thus, the use of the present compositions is not particularly restricted, and the compositions may be applied to any substrate, whether porous or non-porous, for which improved fungal resistance is desired. As used herein, “porous” means a substrate or material that is at least partially liquid permeable, particularly those that absorb or transport liquids applied to a surface through interstices, crevices, cracks, breaks, or other spaces between portions of substrate, such as the pores in wood, the spaces between paper fibers and/or the surface structure of fibers or other filaments incorporated in the material. Examples of porous materials include paper products, sponges, fiber products, woven and non-woven sheeting or fabric, plaster, wood, wood by-products, some decorative laminates, foam, bricks, stone, adhesives etc., while examples of substantially non-porous materials may include ceramics, glass, metal, polymer sheets or films and the like.

Due to the wide variance of conditions under which the various articles may be manufactured, handled, stored, shipped and utilized, construction articles may find particular benefit in having the present formulations applied to at least their exterior surfaces under the controlled conditions available during the manufacturing process. More particularly, construction materials are often manufactured, shipped, stored and used under an extremely wide range of temperature, moisture and light conditions, including long periods of storage and use substantially, if not totally, exposed to the elements. By incorporating at least one surface treated with an antifungal formulation according to the invention on a construction article, transportation and storage losses associated with fungal contamination and growth can be reduced by allowing the articles to be exposed to the elements for several weeks, months or even years, while continuing to remain substantially free of microbial growth.

The present composition can provide some benefit to any construction article to which it is applied. Non-limiting examples of construction articles formed at least in part with substantially porous materials may thus include, but are not limited to, lumber, plywood, roofing shingles, concrete blocks, drywall, grout, concrete, insulation, wall coverings, carpeting, felt, carpet pad, molding, clay roofing tile, plaster, wallboard and ceiling tile. Examples of construction articles formed at least in part with substantially non-porous substrates include tile; hardware such as door handles, hinges, cabinet and drawer pulls and the like; light fixtures; plumbing fixtures; windows and window frames. Clearly certain construction articles may comprise of both porous and non-porous materials, e.g., windows and window frames, and such construction articles are clearly considered to be within the scope of the present invention.

Porous construction articles are expected to find particular benefit in having the present composition applied thereto. That is, since these types of materials are susceptible to water penetration or absorption, they are particularly susceptible to microbial infestation and growth. Further, porous construction articles such as wood and paper products, including plywood and gypsum wallboard are commonly shipped to construction sites and stored in a manner that does not completely prevent at least periodic exposure to the elements and can thus benefit from the inventive coatings and methods.

The compositions of the present invention may be applied to the desired substrate, preferably a construction article, by any known method. Suitable methods of application include, but are not limited to, spraying, rolling, dip coating, painting, pressure-assisted spraying, or combinations of these. In fact, this flexibility is yet another advantage of the present compositions, i.e., special equipment is not required for the application or drying thereof, and thus the compositions are readily and easily applied in manufacturing settings, construction settings, or post-construction, i.e., as by a home-owner or during remodeling to improve the performance of existing materials.

Additional comparative testing was conducted using a range of commercially available biocides/fungicides applied to conventional wallboard paper both without (TABLE 1) and with (TABLE 2) the binder component. In each of the tests reflected in TABLE 2, the binder was an aqueous 7% polyvinyl alcohol solution with a glyoxal cross-linking agent. The compositions were then applied to the wallboard paper at a rate of 1.0% of the net weight of the paper and the fungal resistance of the treated paper was evaluated.

TABLE 1
Mold Inhibition Study of Various Biocidal
Preservatives on Wallboard Paper

Preservative Coating
Concentration
(ppm of Actives)

| | 0 | 1000 | 2000 | 4000 |
|---|---|---|---|---|
| KATHON | 4 | 3 | 2 | 1 |
| ERRIDEN | 4 | 4 | 3 | 2 |
| AMICAL | 4 | 3 | 1 | 0 |
| B-6773 | 4 | 2 | 0 | 0 |
| BRONOPOL | 4 | 4 | 4 | 3 |
| DBNPA | 4 | 4 | 4 | 4 |
| PROXEL | 4 | 3 | 2 | 2 |
| TEKTAMER | 4 | 3 | 3 | 2 |
| BNS | 4 | 4 | 4 | 2 |
| MAQUAT | 4 | 4 | 4 | 4 |
| Boric Acid | 4 | 4 | 4 | 4 |
| Water only | 4 | 4 | 4 | 4 |

Observed growth on specimens:
0 = none
1 = trace (<10%)
2 = light (10-30%)
3 = medium (30-60%)
4 = heavy (60% - complete coverage)

TABLE 2
Mold Inhibition Study of Various Biocidal
Preservatives as Part of a Two-Component Mixture
With A Time Release Binder

Preservative Coating
Concentration
(ppm of Actives)

| | 0 | 1000 | 2000 | 4000 |
|---|---|---|---|---|
| KATHON | 4 | 2 | 1 | 0 |
| ERRIDEN | 4 | 3 | 2 | 1 |
| AMICAL | 4 | 2 | 0 | 0 |
| B-6773 | 4 | 1 | 0 | 0 |
| BRONOPOL | 4 | 3 | 3 | 2 |
| DBNPA | 4 | 3 | 2 | 0 |
| PROXEL | 4 | 2 | 1 | 0 |
| TEKTAMER | 4 | 3 | 3 | 2 |
| BNS | 4 | 2 | 2 | 0 |
| MAQUAT | 4 | 4 | 3 | 3 |
| Boric Acid | 4 | 4 | 4 | 3 |
| Binder only | 4 | 4 | 4 | 4 |

Observed growth on specimens:
0 = none
1 = trace (<10%)
2 = light (10-30%)
3 = medium (30-60%)
4 = heavy (60% - complete coverage)

As reflected above in the comparative data presented in TABLES 1 and 2, the use of a binder composition in conjunction with the biocide improved the overall antifungal performance of the composition. Additional testing was conducted to examine the improvements in the performance of one of the biocides, specifically AMICAL as reflected below in TABLE 3 and thereby determine the biocide concentration level necessary to obtain comparable levels of antifungal activity. As reflected in TABLE 3, the combination of the biocide and the binder composition was able to obtain similar fungal suppression levels with considerably lower quantities of the biocide, particularly when compared to wet application during the paper manufacturing stage.

TABLE 3
Estimated Dose Level Required to
Achieve Minimal Mold Growth Inhibition on
Wallboard Paper¹

| | | Approximate Dose |
|---|---|---|
| Treatment | Method of Application | Required |
| Binder only | Coating Rod | >10,000 ppm |
| | | (did not inhibit |
| | | mold growth) |
| AMICAL Flowable² | Coating Rod | 1500-2000 ppm |
| With Binder | | |
| AMICAL Flowable | Coating Rod | 2000-4000 ppm |
| Only | | |
| AMICAL Flowable | Wet-End of Paper Machine | 8000-10,000 ppm |
| Only | During Formation Stage | |

¹ASTM G21 test scale reading of “1” or less for a minimum thirty-day period
²As received from Dow Chem. Co.

While the present invention has been particularly shown and described with reference to exemplary embodiments thereof, the invention should not be construed as being limited to the particular embodiments set forth herein; rather, these embodiments are provided to convey more fully the concept of the invention to those skilled in the art. Thus, it will be apparent to those of ordinary skill in the art that various changes in form and details may be made therein without departing from the spirit and scope of the present invention as defined by the following claims.

We claim:

1. An antifungal formulation for application to a substrate comprising:
a binder admixture including a film forming resin and a compatible cross-linking agent; and
a preservative admixture including at least one compound exhibiting fungicidal activity and a liquid carrier,
wherein the binder admixture and the preservative admixture are combined at a volume ratio of between 10:1 and 1:1 to create the antifungal formulation.

2. The antifungal formulation according to claim 1, wherein:
the binder admixture includes polyvinyl alcohol.

3. The antifungal formulation according to claim 2, wherein:
the binder admixture further includes a polymeric modifier selected from a group consisting of polyamines, polyamidoamines, polyvinyl acetate, styrene butadiene, polyacrylics, polystyrene maleic anhydride and mixtures thereof.

4. The antifungal formulation according to claim 3, wherein:
the polymeric modifier constitutes from about 0.5% to about 5.0% of the dry weight of the binder admixture.

5. The antifungal formulation according to claim 2, wherein:
the binder admixture includes an additive selected from a group consisting of solubilizers, surfactants, dispersants, dyes, pigments, viscosity modifiers and mixtures thereof.

6. The antifungal formulation according to claim 5, wherein:
the additive includes a compound selected from a group consisting of aldehydes, dialdehydes, metallorganic complexes of titanium and zirconium, borates, dicarboxylic acids, water soluble copper salts and mixtures thereof.

7. The antifungal formulation according to claim 1, wherein:
the compound exhibiting fungicidal activity is selected from a group consisting of organohalogens registered by the Environmental Protection Agency (EPA) for application to paper.

8. The antifungal formulation according to claim 7, wherein:
the compound exhibiting fungicidal activity is selected from a group consisting of isothiazolines, iodoaromatic sulfones, iodoorganics, chloroorganics, bromoorganics, benzoisothiazolines, cyanonitriles, bromonitrostyrene, quaternary ammonium salts and mixtures thereof.

9. A method of increasing the fungal resistance of a substrate comprising:
preparing a binder admixture including a film forming resin and a compatible cross-linking agent;
preparing a preservative admixture including at least one compound exhibiting fungicidal activity and a liquid carrier,
combining the binder admixture and the preservative admixture at a volume ratio of between 10:1 and 1:1 to form an antifungal formulation;
applying the antifungal formulation to the substrate; and
drying the antifungal formulation to form an antifungal coating on the coated substrate.

10. The method of increasing the fungal resistance of a substrate according to claim 9, wherein:
applying the antifungal formulation to the substrate includes a coating process selected from a group consisting of rod coating, roll coating, size press, immersion, spray coating, film coating, flooding, and gravure printing.

11. The method of increasing the fungal resistance of a substrate according to claim 9, wherein:
the antifungal coating constitutes from about 0.2% to about 2% of the weight of the coated substrate.

12. The method of increasing the fungal resistance of a substrate according to claim 9, wherein:
the antifungal coating constitutes from about 0.01% to about 0.2% of the weight of the coated substrate.

13. The method of increasing the fungal resistance of a substrate according to claim 9, wherein:
the substrate being coated has an initial moisture content of from about 5% to about 90%.

14. The method of increasing the fungal resistance of a substrate according to claim 13, wherein:
the coated substrate has a final moisture content of from about 5% to about 10%.

15. The method of increasing the fungal resistance of a substrate according to claim 9, wherein:
the antifungal formulation permeates the substrate.

16. The method of increasing the fungal resistance of a substrate according to claim 15, wherein:
the substrate is a paper product having a weight of from about 5 g/m² to about 40 g/m².

17. A method of increasing the fungal resistance of a substrate comprising:
preparing a binder admixture including a film forming resin, a compatible cross-linking agent and a first dye;
preparing a preservative admixture including at least one compound exhibiting fungicidal activity, a second dye and a liquid carrier,
combining the binder admixture and the preservative admixture at a volume ratio of between 10:1 and 1:1 to form an antifungal formulation having a characteristic color;
applying the antifungal formulation to the substrate to obtain a desired uniformity of the characteristic color on the substrate; and
drying the antifungal formulation to form an antifungal coating on the coated substrate.

18. The method of increasing the fungal resistance of a substrate according to claim 17, wherein:
upon drying, the intensity of the characteristic color of the antifungal formulation is reduced by at least 50%.

19. The method of increasing the fungal resistance of a substrate according to claim 17, wherein:
after drying the first and second dyes are fixed to the substrate to a degree sufficient to suppress dye leaching from the coated substrate into latex or oil base fluids.

20. The method of increasing the fungal resistance of a substrate according to claim 17, further comprising:
combining the binder admixture and the preservative admixture with a fluid diluent before applying the antifungal formulation to the substrate.
